(19) United States
(12) Patent Application Publication
(10) Pub. No.: US 2022/0049074 A1
(43) Pub. Date: Feb. 17, 2022

(54) MASTER ROLL FORMULATIONS FOR PRE-STRETCHED FILMS

(71) Applicant: Paragon Films, Inc., Broken Arrow, OK (US)

(72) Inventor: Tom ROUDEBUSH, Broken Arrow, OK (US)

(73) Assignee: Paragon Films, Inc., Broken Arrow, OK (US)

(21) Appl. No.: 17/321,800

(22) Filed: May 17, 2021

Related U.S. Application Data
(63) Continuation of application No. 17/063,333, filed on Oct. 5, 2020, now abandoned.
(60) Provisional application No. 62/910,851, filed on Oct. 4, 2019.

(51) Int. Cl. C08L 23/06; C08L 23/14; C08L 23/20; B29C 55/02

(52) U.S. Cl. CPC C08L 23/06; C08L 23/14; C08L 23/20; C08L 2207/066; C08L 2203/16; C08L 2205/02; C08L 2205/03; B29C 55/023

(57) ABSTRACT

According to one aspect of the invention, a film is produced comprising core layers of lower density m-LLDPE (e.g., 0.914 density or lower) and RCPP (a polypropylene resin comprising an ethylene content). By adding a RCPP further comprising a catalyzed metallocene, predefined desirable properties are enhanced that improve the integrity of the film while assuring that performance requirements are achieved and maximized. According to a further aspect, PolylsoButlyene content is used to improve cling layer characteristics on both skins. According to still further aspects, the compositions and methods described herein result in master rolls, which typically comprise 70 gauge+ master roll content, having desired results achieved using only 45 gauge master roll.

### FIELD

The present invention relates generally to compositions and methods for producing a stretch film, and in a particular though non-limiting embodiment to a master roll formulation that creates or enhances desirable properties when used to make pre-stretched films.

### BACKGROUND

A wide variety of bundling and packaging applications use stretch films. For example, machine and hand stretch films routinely secure bulky loads such as boxes, merchandise, produce, equipment, parts and other similar items on pallets.

After loads are wrapped with stretch film, they are placed onto trucks, trains, ships, and the like for transportation. Wrapped pallets and other wrapped loads are placed next to each other during transportation, with the outside layers of the stretch film ultimately securing the loads.

However, film degeneration can occur both during and after delivery. For example, film distortions and degradation during packing and transit coupled with subsequent storage and usage conditions can deteriorate film quality to the point where significant amounts of film are unfit for intended commercial purposes, thereby causing product and money loss due to wasteful discard and, at most, only minimal remediation opportunity.

It is known that master roll formulations can have a great effect on the performance characteristics of stretch film product, and thus one method of preventing such damage and waste is to carefully tailor master roll compositions so to encourage desirable resultant performance properties in commercial product lines.

For example, one past effort comprises a composition of film having a lower density m-LLDPE disposed in chemical communication with an m-RCPP. Other past efforts involve compositions employing minimal amounts of polypropylene, though each of the foregoing approaches suffer from certain deleterious technical issues that could be improved upon by focusing on the composition of tailored master roll formulations.

There is, therefore, a long-felt but unmet need for master roll compositions that complement the commercial needs of both producers and end users of pre-stretch films.

### SUMMARY

Master rolls are used in the pre-stretch process to make hand films that have already been oriented. By pre-stretching or pre-orienting the film, the end user can apply a film having favorable properties without the need of manually adding the stretch. Some stretch is added for tension, but most of the strength is already in the film.

Such master roll formulations are ideal for creating a thinner, more effective finished product. Thinner product that performs the same (or nearly so) lends significant cost advantage to end users both in absolute terms with respect to film production costs, but also in lost opportunity costs attributable to waste and premature disposal.

For example, thinner gauge master roll compositions allow a significant draw-down of the material required to create a thinner product. In contrast, prior existing technologies generally involve thicker master rolls that result in higher costs and inferior efficacy.

In a specific though non-limiting embodiment, a film is produced comprising core layers of lower density m-LLDPE (e.g., 0.914 density or lower) and RCPP (a polypropylene resin comprising an ethylene content). By adding a RCPP further comprising a catalyzed metallocene, predefined desirable properties are enhanced that improve the integrity of the film while assuring that performance requirements are achieved and maximized.

In another embodiment, PolylsoButlyene content is used to improve cling layer characteristics on both skins. In a still further embodiment, the compositions and methods described herein result in master rolls (which typically comprise 70 gauge+ master roll content) having desired results achieved using only 45 gauge master roll.

Moreover, while a lower density resin will typically result in higher puncture performance, it has been found that such compositions have a reduced load holding force, especially when the master roll is produced using typical machine film processing methods, as it is well known that a higher density resin will yield a higher FTS.

Polypropylene has traditionally not been used in hand films, as it includes a more expensive resin and does not provide sufficient benefit in normal hand film applications. Even in the rare instances where manufacturers of pre-stretched films do add polypropylene, it is generally found only in trace percentages.

In order to overcome these issues, PIB is added in the skin layers along with an Octene LLDPE. PIB is an additive commonly used for cling. The present inventor has found that by using PIB in both skins, performance of the carrier resin is improved, and skins comprising PIB (rather than the previously known method of choosing a skin resin specific to cling and thereby losing other properties) and Octene LLDPE carrier results in good clarity and extensibility without the risk of splitting the film.

Other resins having a higher “natural cling” might allow the manufacturer to save money on PIB, but when those resins are used in a pre-stretched film they tend to be “splitty” and/or have poor cross directional strength because they typically comprise Hexene LLDPE, which naturally has more extractables.

In the present invention, improved strength or FTS is achieved by a combination of the master roll composition and the method of the manufacturing process. By using a thin or heavily drawn down 45 gauge master roll, significant alignment of polymer chains typical in a much thinner machine film is achieved. For example, by adding significant pre-stretch to the master roll during the pre-stretching process, stiffness is introduced into an otherwise softer resin formulation.

Without a softer resin formulation in the master roll, a thinner pre-stretched film would not be possible because the pre-stretched film would either break before it is drawn down to a desired thickness, or be so brittle that an end user would be effectively unable to use the film in necessary commercial applications.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A composition for producing a stretch film, said composition comprising a master roll formulation that creates or enhances desirable properties when used to make stretch films.
